(19) United States
(12) Patent Application Publication
(10) Pub. No.: US 2024/0200490 A1
(43) Pub. Date: Jun. 20, 2024

(54) HYDROPHILIC POLYETHER AMINE SOLUTION AND USES THEREOF

(71) Applicant: Huntsman Petrochemical LLC, The Woodlands, TX (US)

(72) Inventor: Haibo ZHAO, The Woodlands, TX (US)

(21) Appl. No.: 18/286,404

(22) PCT Filed: May 5, 2022
(86) PCT No.: PCT/US2022/027779

§ 371 Date: Oct. 11, 2023

Related U.S. Application Data
(60) Provisional application No. 63/184,449, filed on May 5, 2021.

(51) Int. Cl. F02B 77/04; C08J 3/05; C11D 7/32

(52) U.S. Cl. CPC F02B 77/04; C08J 3/05; C11D 7/3227; C08J 2371/02; C11D 2111/20

(57) ABSTRACT

System Solutions and methods for cleaning the air intake valve of a GDI engine during engine operation with a PEA-water solution injection.

### CROSS-REFERENCE TO RELATED APPLICATIONS

This application claims priority to U.S. Provisional Application No. 63/184,449 filed May 5, 2021. The noted application(s) are incorporated herein by reference.

### FIELD

The present disclosure generally relates to a system and method for controlling carbonaceous deposits. More specifically, the present disclosure relates to a hydrophilic polyether amine (PEA)-water solution used to control the amount of carbonaceous deposit buildup in gasoline direct injection (GDI) engines.

### BACKGROUND

The combustion of hydrocarbon motor fuel within an internal combustion engine is known to form and accumulate carbonaceous deposits throughout the engine due to the oxidation and polymerization of hydrocarbon fuel. The deposits can affect various parts of the engine including, without limitation, carburetor ports, throttle bodies, venturis, intake ports, intake valves, and the like. The buildup of carbonaceous deposits throughout the engine can cause severe functionality issues including, without limitation, increased fuel consumption, increased production of exhaust pollutants, engine knocking, injector sticking, plugging, leakage, and delayed injection.

Such deposits have typically been controlled through the use of an enhanced fuel, having one or more detergents or additives therein. The detergents and additives are used to inhibit the formation of carbonaceous deposits and clean the combustion chamber when the enhanced fuel is present. It is known that hydrocarbon fuels containing polyether amine (PEA) based detergents are excellent deposit control agents for both port fuel injection (PFI) and GDI engines. Such detergents work well for both preventative and remedy operations. For example, PEA-based fuel detergents are able to control deposit formation and buildup in the fuel line, fuel intake valve, fuel injectors and prevent additional deposits within combustion chamber. There are many patents that describe the use of PEA detergents in hydrocarbon fuels including, without limitation, U.S. Pat. Nos. 5,112,364; 6,548,461; 6,217,624; 6,193,767; and 5,660,601. Typically, PEA-based fuel detergents are hydrophobic, allowing for solubility within the hydrocarbon fuel.

Recently there has been an increase in the amount of new cars that are using GDI engines due to the improved fuel economy over PFI engines. However, one of the shortcomings of GDI engines is that they accrue dry deposits on the air intake valve requiring professional cleaning. Despite the state of the art, there is continuous need for the development of a fuel detergent or additive that can prevent and/or control the buildup of carbonaceous deposits on the air intake valve during engine operation.

### DETAILED DESCRIPTION

Before explaining aspects of the present disclosure in detail, it is to be understood that the present disclosure is not limited in its application to the details of construction and the arrangement of components or steps or methodologies set forth in the following description. The present disclosure is capable of other embodiments or of being practiced or carried out in various ways. Also, it is to be understood that the phraseology and terminology employed herein is for the purpose of description and should not be regarded as limiting.

Unless otherwise defined herein, technical terms used in connection with the present disclosure shall have the meanings that are commonly understood by those having ordinary skill in the art. Further, unless otherwise required by context, singular terms shall include pluralities and plural terms shall include the singular.

All patents, published patent applications, and non-patent publications mentioned in the specification are indicative of the level of skill of those skilled in the art to which the present disclosure pertains. All patents, published patent applications, and non-patent publications referenced in any portion of this application are herein expressly incorporated by reference in their entirety to the same extent as if each individual patent or publication was specifically and individually indicated to be incorporated by reference to the extent that they do not contradict the instant disclosure.

All of the compositions and/or methods disclosed herein can be made and executed without undue experimentation in light of the present disclosure. While the compositions and methods of the present disclosure have been described in terms of preferred embodiments, it will be apparent to those having ordinary skill in the art that variations may be applied to the compositions and/or methods and in the steps or sequences of steps of the methods described herein without departing from the concept, spirit, and scope of the present disclosure. All such similar substitutes and modifications apparent to those skilled in the art are deemed to be within the spirit, scope, and concept of the present disclosure.

As utilized in accordance with the present disclosure, the following terms, unless otherwise indicated, shall be understood to have the following meanings.

The use of the word “a” or “an”, when used in conjunction with the term “comprising”, “including”, “having”, or “containing” (or variations of such terms) may mean “one”, but it is also consistent with the meaning of “one or more”, “at least one”, and “one or more than one”.

The use of the term “or” is used to mean “and/or” unless clearly indicated to refer solely to alternatives and only if the alternatives are mutually exclusive.

If the specification states a component or feature “may,” “can,” “could,” or “might” be included or have a characteristic, that particular component or feature is not required to be included or have the characteristic.

Throughout this disclosure, the term “about” is used to indicate that a value includes the inherent variation of error for the quantifying device, mechanism, or method, or the inherent variation that exists among the subject(s) to be measured. For example, but not by way of limitation, when the term “about” is used, the designated value to which it refers may vary by plus or minus ten percent, or nine percent, or eight percent, or seven percent, or six percent, or five percent, or four percent, or three percent, or two percent, or one percent, or one or more fractions therebetween.

The use of “at least one” will be understood to include one as well as any quantity more than one, including but not limited to, 1, 2, 3, 4, 5, 10, 15, 20, 30, 40, 50, 100, etc. The term “at least one” may extend up to 100 or 1000 or more depending on the term to which it refers. In addition, the quantities of 100/1000 are not to be considered as limiting since lower or higher limits may also produce satisfactory results.

In addition, the phrase “at least one of X, Y, and Z” will be understood to include X alone, Y alone, and Z alone, as well as any combination of X, Y, and Z. Likewise, the phrase “at least one of X and Y” will be understood to include X alone, Y alone, as well as any combination of X and Y. Additionally, it is to be understood that the phrase “at least one of” can be used with any number of components and have the similar meanings as set forth above.

The use of ordinal number terminology (i.e., “first”, “second”, “third”, “fourth”, etc.) is solely for the purpose of differentiating between two or more items and, unless otherwise stated, is not meant to imply any sequence or order or importance to one item over another or any order of addition.

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The phrases “or combinations thereof” and “and combinations thereof” as used herein refers to all permutations and combinations of the listed items preceding the term. For example, “A, B, C, or combinations thereof” is intended to include at least one of: A, B, C, AB, AC, BC, or ABC and, if order is important in a particular context, also BA, CA, CB, CBA, BCA, ACB, BAC, or CAB. Continuing with this example, expressly included are combinations that contain repeats of one or more items or terms such as BB, AAA, CC, AABB, AACC, ABCCCC, CBBAAA, CABBB, and so forth. The skilled artisan will understand that typically there is no limit on the number of items or terms in any combination, unless otherwise apparent from the context. In the same light, the term “and combinations thereof” when used with the phrase “selected from the group consisting of” refers to all permutations and combinations of the listed items preceding the phrase.

The phrases “in one embodiment”, “in an embodiment”, “according to one embodiment”, and the like generally mean the particular feature, structure, or characteristic following the phrase is included in at least one embodiment of the present disclosure, and may be included in more than one embodiment of the present disclosure. Importantly, such phrases are non-limiting and do not necessarily refer to the same embodiment but, of course, can refer to one or more preceding and/or succeeding embodiments. For example, in the appended claims, any of the claimed embodiments can be used in any combination.

As used herein, the term “ambient temperature” refers to the temperature of the surrounding work environment (e.g., the temperature of the area, building or room where the curable composition is used), exclusive of any temperature changes that occur as a result of the direct application of heat to the curable composition to facilitate curing. The ambient temperature is typically between about 10° C. and about 30° C., more specifically about 15° C. and about 25° C.

More and more new cars are using gasoline direct injection (GDI) engines due to the increased fuel economy. One of the shortcomings of the GDI engine is that dry carbonaceous deposits can form in the air intake valve. Standard gasoline GDI engines do not have any liquid fuel that flows through the air intake valve, preventing detergents present in the fuel from reacting with the deposits on the air intake valve. Such deposits can be caused by the vapor from positive crankcase ventilation (PCV), back splash of the hydrocarbon fuel, and partially burned fuel from the combustion chamber when the valve is in the open position. Air intake valve deposits can restrict both the ability of the valve to open and close as well as the air inlet tract area and can reduce the engine's volumetric efficiency. Additionally, the presence of air intake valve deposits can cause various adverse effects including, without limitation, valve burning, delayed valve motion, improper valve seating, reduce volumetric efficiency, poor starting, engine stalling, rough running, hesitation when suddenly accelerating, engine power restriction, increased fuel consumption, and increased emissions. Currently, an intake valve must be cleaned by a trained professional in a service station; there is no effective way to keep the intake valve clean or actively clean the valve during the operation.

Recently, a new GDI engine has been introduced that injects water to the combustion chamber through the air intake valve in order to improve the fuel economy of the engine. However, the added water is not able to clean the carbonaceous deposits that form on the air intake valve. Disclosed herein is a system and method for cleaning the air intake valve of an engine during operation. Specifically, the systems and methods described herein includes adding one or more water-soluble detergent to a water tank, such that as the water is injected into the combustion chamber through the air intake valve the water-soluble detergents contact the surface of the valve.

The carbonaceous deposits that can form on the air intake valves of GDI engines can be partially oxidized hydrocarbon from the fuels or lubricants moving through the engine; such deposits can be produced from thermally and oxidatively unstable fuel or from the oxidation of the lubricating oil products. The carbonaceous deposits can include a large acid group sites. The amine head group of water-soluble PEAs can produce strong interactions with such acid group sites on the deposits modifying the deposits. The hydrophilic tail of the water-soluble PEAs allows the PEA modified carbonaceous deposits to be dispersed into the water solution as it passes through the air intake valve during engine operation. Essentially, the hydrophilic PEAs lift the deposits off the intake valve and suspend them within the aqueous medium.

Various water-soluble PEAs are compatible with the presently disclosed systems and methods. The one or more monofunctional water-soluble PEAs can be dissolved in water introduced into the water tank, creating a PEA-water solution. The PEA-water solution is injected through air intake valve as the engine operates contacting the carbonaceous deposits on the air intake valve. As such, the PEA-water solution cleans the carbonaceous deposits on the air intake valve as the solution passes through. Polyether amines that are suitable to clean such carbonaceous deposits must have enough water solubility to remain in solution within the water tank. In addition to cleaning deposits from the surface of the air intake valve, PEAs can also reduce the freezing point of the solution and improve engine operation during the colder winter season. Suitable PEA structures include, without limitation:

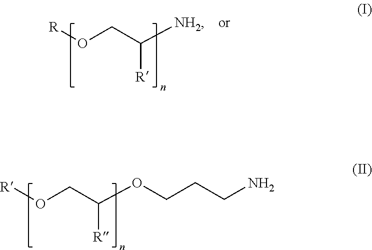

Where R and R′ are each one of an alkyl, an aryl, or a cycloalkyl group and R″ is one of hydrogen, a methyl group, an ethyl group, or a combination thereof.

In at least one example, the water-soluble PEA can be at least about 200 MW in size. In an alternative example, the water-soluble PEA can be at least about 1000 MW or greater in size. In at least one example, the water-soluble PEA can include, without limitation, monoamines (such as Jeffamine® M-600, Jeffamine® M-1000, Jeffamine® M-2005, Jeffamine® M-2070) and other water-soluble PEAs in accordance with Structures (I) or (II), above. The Jeffamine® materials are commercially available from the Huntsman Corp.

In at least one example, the water-soluble PEA should be present in the water-soluble PEA-water solution in an amount of about 50 parts per million (ppm) to about 5000 ppm. In an additional example, the water-soluble PEA should be present in an amount of at least about 50 ppm, at least about 100 ppm, at least about 500 ppm, at least about 1000 ppm, at least about 2000 ppm, at least about 3000 ppm, at least about 5000 ppm. In an additional example, the water-soluble PEA should be present in an amount of less than about 5000 ppm, less than about 4000 ppm, less than about 3000 ppm, less than about 2000 ppm, less than about 1000 ppm, less than about 500 ppm, less than about 400 ppm, less than about 300 ppm, less than about 200 ppm, less than about 100 ppm.

Water-soluble PEAs in accordance with the present disclosure must include a sufficient amount of ethylene oxide in the polyether backbone to allow the PEA to be water soluble. In at least one example, the PEA-water solution should have at least 1% water solubility under ambient temperatures. In an alternative example, the PEA-water solution should have at least 10% or higher water solubility.

The methods and systems described herein can be used in automobile industries including, without limitation, additive companies and fuel companies.

From the above description, it is clear that the present disclosure is well adapted to carry out the object and to attain the advantages mentioned herein as well as those inherent in the present disclosure. While exemplary embodiments of the present disclosure have been described for the purposes of the disclosure, it will be understood that numerous changes may be made which will readily suggest themselves to those skilled in the art which can be accomplished without departing from the scope of the present disclosure and the appended claims.

What is claimed is:

1. A method for cleaning a air intake valve of a gasoline direct injection (GDI) GDI engine during engine operation using a polyether amine (PEA)-water solution.

2. The method of claim 1, wherein the PEA-water solution includes one or more water-soluble PEAs.

3. The method of claim 2, wherein the one or more water-soluble PEAs has the structure 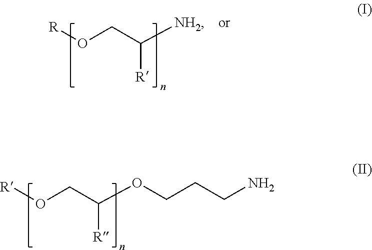
where R and R′ are each one of an alkyl, an aryl, or a cycloalkyl group, and R″ is one of hydrogen, a methyl group, an ethyl group, or a combination thereof.

4. The method of claim 3, wherein the PEA-water solution has at least 1% water solubility under ambient temperatures.

5. The method of claim 3, wherein the PEA-water solution has at least 10% or higher water solubility.

6. The method of claim 2, wherein the water-soluble PEA is present in the PEA-water solution in an amount of about 50 parts per million (ppm) to about 5000 ppm.

7. The method of claim 6, wherein the water-soluble PEA is present in an amount of about 500 ppm to about 2000 ppm.

8. An aqueous solution for controlling deposits on an air intake valve of a gasoline direct injection (GDI) comprising:
a water-soluble polyether amine (PEA) having the structure: 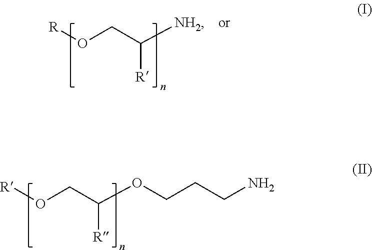
water.

9. The aqueous solution of claim 8, having at least 10% or higher water solubility.

10. The aqueous solution of claim 8, wherein the water-soluble PEA is present an amount of about 50 parts per million (ppm) to about 5000 ppm.

11. The aqueous solution of claim 10, wherein the water-soluble PEA is present in an amount of about 500 ppm to about 2000 ppm.
